(19) United States
(12) Patent Application Publication
(10) Pub. No.: US 2024/0114323 A1
(43) Pub. Date: Apr. 4, 2024

(54) APPARATUS AND METHOD FOR PROVIDING SERVICE FUNCTION CHAINING SERVICE EXPOSURE IN WIRELESS COMMUNICATION SYSTEM

(71) Applicant: ELECTRONICS AND TELECOMMUNICATIONS RESEARCH INSTITUTE, Daejeon (KR)

(72) Inventors: Yoo Hwa KANG, Daejeon (KR); Namseok KO, Daejeon (KR); Changki KIM, Daejeon (KR)

(21) Appl. No.: 18/476,036

(22) Filed: Sep. 27, 2023

(30) Foreign Application Priority Data
Sep. 30, 2022 (KR) 10-2022-0125316
Apr. 25, 2023 (KR) 10-2023-0054040

(51) Int. Cl. H04W 4/50

(52) U.S. Cl. CPC H04W 4/50

(57) ABSTRACT

An apparatus and method for providing an SFC service exposure function in a wireless communication system is proposed. The apparatus and method relates to a wireless communication system in general, and specifically, the method includes a process of requesting a service function chaining (SFC) service from a network exposure function (NEF), wherein, in the process of requesting the SFC service, the SFC service is requested by inputting an SFC policy identifier and a metadata value on a basis of an Nnef_TrafficInfluence service interface, and the SFC policy identifier is mapped to an identifier defined in a policy and charging control (PCC) rule.

### TECHNOLOGY FIELD

The present disclosure relates generally to a wireless communication system and, more particularly, to an apparatus and method for providing an SFC service exposure function in a wireless communication system.

### BACKGROUND OF THE DISCLOSURE

In a 5G communication system, an N6-LAN service is one of interfaces used instead of Gi/SGi-LAN that is mainly used in LTE, and mobile communication operators may provide various additional services through the N6_LAN service.

A service function chaining (SFC) technology is one of methods by which the mobile communication operators may provide the various additional services through the service function chaining. The SFC technology performs functions such as DPI, NAT, firewall, policy control, traffic/content optimization, and the like, and packets may be processed within a service function chain.

The SFC may operate in a way of extracting a part of a packet, determining which service functions (SF) to perform on the basis of this extracted part, and then selecting a next SF. When the service functions are connected to each other as a chain by using the SFC, a process of network packet processing may be simplified and various additional services may be provided.

The mobile communication operators may provide various additional services through various types of service functions through the N6-LAN. 3GPP Rel-18 started a standard study to perform N6-LAN traffic control by using IETF service function chaining (SFC) technology.

### CONTENT OF THE INVENTION

### The Object of the Invention

Based on the above-described description, the present disclosure provides an apparatus and method for providing a service function chaining (SFC) service exposure function in a wireless communication system.

In addition, the present disclosure provides an apparatus and method for defining application programming interfaces (APIs) of an SFC exposure service in a wireless communication system and performing the SFC exposure service.

In addition, the present disclosure provides an apparatus and method for performing an SFC exposure service and SFC exposure service application programming interfaces (APIs) provided by a 5G system (5GS), so that an application function (AF) may request SFC settings from the 5GS in a wireless communication system.

### Technical Object of the Invention

According to various exemplary embodiments of the present disclosure, there is provided a method of operating an application function (AF) in a wireless communication system, the method including: a process of requesting a service function chaining (SFC) service from a network exposure function (NEF), wherein, in the process of requesting the SFC service, the SFC service is requested by inputting an SFC policy identifier and a metadata value on a basis of an Nnef_TrafficInfluence service interface, and the SFC policy identifier is mapped to an identifier defined in a policy and charging control (PCC) rule.

According to various exemplary embodiments of the present disclosure, there is provided a method of operating a network exposure function (NEF) in a wireless communication system, the method including: a process of receiving a request of a service function chaining (SFC) service from an application function (AF), wherein, in the process of receiving the request of the SFC service, the request of the SFC service is received by inputting an SFC policy identifier and a metadata value on a basis of an Nnef_TrafficInfluence service interface, and the SFC policy identifier is mapped to an identifier defined in a policy and charging control (PCC) rule.

According to various exemplary embodiments of the present disclosure, there is provided an apparatus using an application function (AF) in a wireless communication system, the apparatus including: a transmitting and receiving unit; and a controller operably connected to the transmitting and receiving unit, wherein the controller requests an SFC service from a network exposure function (NEF), the controller requests the SFC service by inputting an SFC policy identifier and a metadata value on a basis of an Nnef_TrafficInfluence service interface in order to request the SFC service, and the SFC policy identifier is mapped to an identifier defined in a PCC rule.

According to various exemplary embodiments of the present disclosure, there is provided an apparatus using a network exposure function (NEF) in a wireless communication system, the apparatus including: a transmitting and receiving unit; and a controller operably connected to the transmitting and receiving unit, wherein the controller receives a request of an SFC service from an application function (AF), the controller receives the request of the SFC service by inputting an SFC policy identifier and a metadata value on a basis of an Nnef_TrafficInfluence service interface in order to receive the request of the SFC service, and the SFC policy identifier is mapped to an identifier defined in a PCC rule.

### Effect of the Invention

The apparatus and method according to various exemplary embodiments of the present disclosure provide an SFC exposure service when the 5G system (5GS) applies service function chaining (SFC) technology to 5G N6-LAN services, so that the N6-LAN services for specific applications may be provided according to requests of service providers as well as mobile communication operators.

The effects of the present disclosure are not limited to the above-mentioned effects, and other different effects that are not mentioned will be clearly understood by those skilled in the art, to which the present disclosure belongs, from the following description.

### BRIEF DESCRIPTION OF THE DRAWINGS

FIG. 1 is a view illustrating an example of configuring N6-LAN according to various exemplary embodiments of the present disclosure.

FIG. 2 is a view illustrating a signal flow diagram for a procedure of receiving SFC information requested by an AF and managing and processing the SFC information in a 5GS according to an exemplary embodiment of the present disclosure.

FIG. 3 is a view illustrating a signal flow diagram of a procedure in which an AF receives SFC information requested for one specific user and manages and processes the received SFC information in a 5GS according to the exemplary embodiment of the present disclosure.

FIG. 4 is a view illustrating a configuration of a network entity in a wireless communication system according to various exemplary embodiments of the present disclosure.

### DETAILED DESCRIPTION OF THE EMBODIMENTS

The terms used in the present disclosure are only used to describe specific exemplary embodiments, and may not be intended to limit the scope of other exemplary embodiments. The singular forms may include the plural forms as well, unless the context clearly indicates otherwise. The terms including technical and scientific terms used herein have the same meaning as commonly understood by those skilled in the art described in the present disclosure. Among the terms used in the present disclosure, terms defined in a general dictionary may be interpreted as having the same or similar meaning as the meaning in the context of the related art, and are not interpreted in an ideal or excessively formal meaning unless explicitly defined in the present disclosure. In some cases, even the terms defined in the present disclosure cannot be interpreted to exclude the exemplary embodiments of the present disclosure.

In various exemplary embodiments of the present disclosure described below, a hardware approach method is described as an example. However, since the various exemplary embodiments of the present disclosure include technology using both hardware and software, the various exemplary embodiments of the present disclosure do not exclude a software-based approach method.

Hereinafter, the present disclosure relates to an apparatus and method for providing an SFC service exposure function in a wireless communication system. Specifically, the present disclosure describes technology for defining application programming interfaces (APIs) of an SFC exposure service and performing the SFC exposure service in the wireless communication system.

In the following description, terms referring to signals, terms referring to channels, terms referring to control information, terms referring to network entities, terms referring to components of an apparatus, and the like are used and illustrated for convenience of the description. Accordingly, the present disclosure is not limited to the terms described below, but other terms having equivalent technical meanings may be used.

In addition, the present disclosure describes various exemplary embodiments by using terms used in some communication standards (e.g., 3rd Generation Partnership Project, 3GPP), but these are just examples for description. The various exemplary embodiments of the present disclosure may be easily modified and applied to other communication systems.

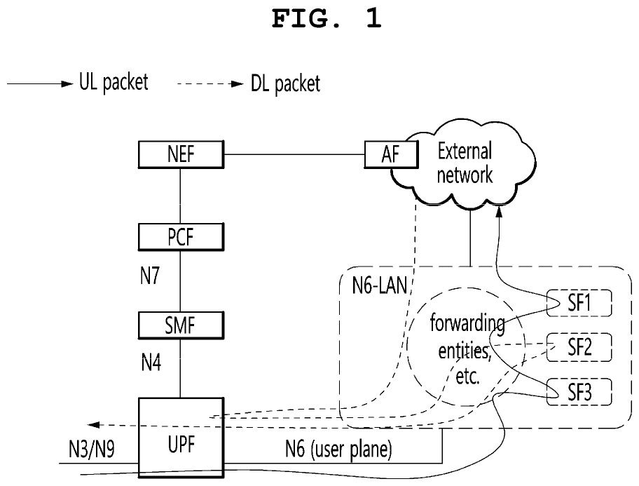

FIG. 1 is a view illustrating an example of configuring N6-LAN according to various exemplary embodiments of the present disclosure. Specifically, FIG. 1 shows an example of configuring the N6-LAN, which is included in a 3GPP TR 23.700-18 document.

Referring to FIG. 1, a standard study document of the 3GPP TR 23.700-18 (i.e., the study on system enabler for service function chaining, Rel-18) may comply with IETF RFC 7665: Service Function Chaining (SFC) Architecture.

A service function path (SFP) may refer to a path of service functions applied sequentially to process specific traffic. The SFP may be used to determine which path the specific traffic will follow and which service functions the specific traffic will pass through. The SFP may include a set of service function IDs, lengths, and sequences.

A network entity function (NEF) in FIG. 1 refers to a function that exposes network resources by connecting to an external system in a 5G network.

A policy control function (PCF) is a function of managing policies in the 5G network and refers to a function of applying and managing various policies related to service requests.

A session management function (SMF) is a function that performs session management in the 5G network and may be responsible for the session management and control with user equipment (UE).

A user plane function (UPF) is a function responsible for data packet delivery in the 5G network, and may perform IP address conversion, traffic management, and the like for the packet data delivery. An AF is a function that processes and manages data related to applications in the 5G network, and may perform network resource allocation and service quality management.

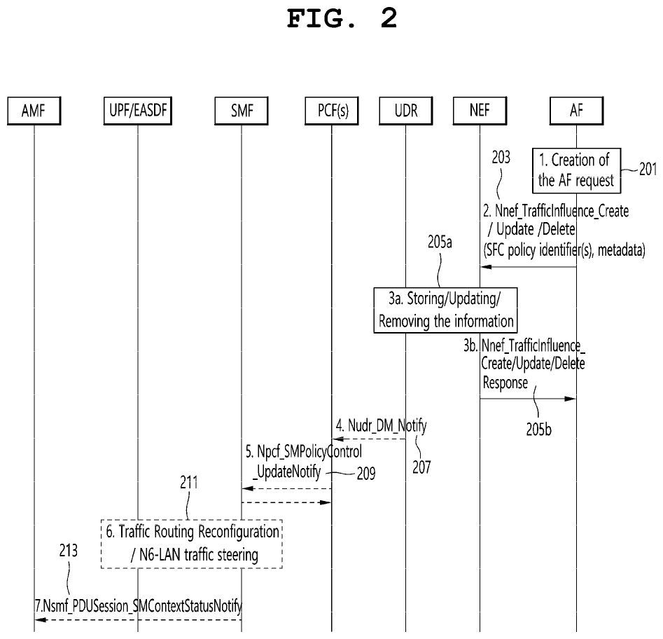

FIG. 2 shows a signal flow diagram for a procedure of receiving SFC information requested by the AF and managing and processing the SFC information in the 5GS according to an exemplary embodiment of the present disclosure.

Referring to FIG. 2, in operation 201, when a service provider desires to apply a service function chaining (SFC) service to a specific application, the service provider may request an SFC policy, which is agreed upon in advance through an application function (AF), from a 5G system (5GS).

In operation 203, the AF may request the SFC service from a network exposure function (NEF) on the basis of Nnef_TrafficInfluence service.

According to the exemplary embodiment, a message for requesting the SFC service may be an Nnef_TrafficInfluence_Create/Update/Delete message.

According to the exemplary embodiment, the Nnef_TrafficInfluence_Create/Update/Delete may be one of NEF messages used in the 5G network.

According to the exemplary embodiment, TrafficInfluence may define data network influence factors related to service quality (SQ), bandwidth reduction, content optimization, and the like. The Nnef_TrafficInfluence_Create/Update/Delete message is used to create, update, and delete such TrafficInfluence information. The Nnef_TrafficInfluence_Create/Update/Delete message may support creating, updating, and deleting the TrafficInfluence information in other 5G network components such as a policy control function (PCF).

According to the exemplary embodiment, requesting a SFC service may comply with 3GPP TS 23.502.

According to the exemplary embodiment, additional information for SFC may be defined as follows on the basis of Nnef_TrafficInfluence service operation. The Nnef_TrafficInfluence service is used by an AF that requests routing, including traffic steering, from an NEF. In order to initially request the traffic routing, the AF makes a request to the NEF by using Nnef_TrafficInfluence_Create service operation including parameters related to the request, and in a case of requesting a routing change for the corresponding traffic thereafter, the AF requests updating of the existing traffic routing from the NEF by using Nnef_TrafficInfluence_Update service operation.
Nnef_TrafficInfluence_Create operation: Input (SFC policy identifier(s), metadata)
Nnef_TrafficInfluence_Update operation: Input (SFC policy identifier(s), metadata)

An SFC policy identifier may be an identifier (ID) indicating a SFC policy and may be a value agreed upon in advance between a 5GS and a service provider.

In addition, the SFC policy identifier may have a value present for each traffic uplink/downlink direction. That is, even for the same application traffic, the SFC policy identifier may use values different from each other in order to distinguish the SFC policy according to the uplink/downlink direction.

The AF may also add metadata, which may be values used by service functions (SFs) within the SFC service. Accordingly, the 5GS may only perform a task of adding a metadata value received from the AF to a packet without using the metadata value within the 5GS.

In operation 205, specifically in operation 205a, the NEF may store information, requested by the AF, including the SFC policy identifier and the metadata value in a unified data repository (UDR).

In operation 205, specifically in operation 205b, the NEF may transmit a Nnef_TrafficInfluence_Create/Update/Delete Response message in response to operation 203.

According to the exemplary embodiment, the Nnef_TrafficInfluence_Create/Update/Delete Response message is a message generated by the network exposure function (NEF), and may be transmitted in a case where the Traffic Influence information is successfully created, updated, or deleted. The Nnef_TrafficInfluence_Create/Update/Delete Response message may include an ID and status information of the Traffic Influence information that has been created, updated, or deleted.

In operation 207, the UDR may inform PCF(s) that UDR information has been updated.

According to the exemplary embodiment, in operation 207, a Nudr_DM_Notify message may be transmitted to notify that the UDR information has been updated.

According to the exemplary embodiment, the Nudr_DM_Notify is one of messages used in a 3GPP 5G network. The Nudr_DM_Notify is used to notify other systems of changes in UDR data repository.

In operation 209, the PCF may map the SFC policy identifier input from the AF to an identifier defined in a PCC rule. The identifier defined in the policy and charging control (PCC) rule is an ID used inside the 5GS and may be mapped as follows.

According to a first method, an existing traffic steering policy (TSP) ID may be used as is.

According to a second method, an SFC ID input from the AF may be used as is.

According to a third method, a service function path (SFP) ID that a UPF will perform on an actual packet may be used.

In operation 209, the PCF may transmit new policy information including the identifier and metadata, which are mapped into one, to a session management function (SMF) according to the first to third methods.

In operation 209, the PCF may transmit an Npcf_SMPolicyControl_UpdateNotify message. According to the exemplary embodiment, the Npcf_SMPolicyControl_UpdateNotify message is one of the messages used in the 5G network, and is a message in which the PCF(s) request the SMF to update SM Policy Control information. The SMF that receives the Npcf_SMPolicyControl_UpdateNotify message may receive and apply the updated SM policy control information from the PCF(s). Through this way, the PCF(s) may transmit and control various services and service level-specific user data processing rules to the SMF.

In operation 211, the SMF may transmit forwarding action rule (FAR) forwarding information, including the SFC policy information (i.e., the identifier and metadata) received from the PCF, to the UPF.

According to the exemplary embodiment, the SFC policy information may include information about the identifier and metadata.

According to the exemplary embodiment, SFC policy information for a piece of application traffic may simultaneously include the first method and second method below.

The first method may include N6-LAN traffic steering, which is the SFC policy information used by the 5GS.

The second method may include AF-influenced traffic steering, which is the SFC policy requested by the AF.

Traffic steering information transmitted from the SMF to the UPF may simultaneously apply the first method and second method described above to a piece of traffic. For example, respective SFC policy information different from each other may be applied depending on an uplink/downlink direction of traffic, and in a case where two pieces of SFC policy information exist in the same direction, one of the two pieces of SFC policy information may have to be applied according to priority.

According to the exemplary embodiment, selection according to the priority may be performed by the PCF or SMF.

The SMF may transmit an Nsmf_PDUSession_SMContextStatusNotify message to an AMF. In operation 213, the Nsmf_PDUSession_SMContextStatusNotify message is one of messages used in a 5G standalone (SA) core, and is a message that transmits SM context (status change) information from the session management function (SMF) to the AMF.

According to the exemplary embodiment, the SM context may be used to maintain information related to a PDU session. Accordingly, through the Nsmf_PDUSession_SMContextStatusNotify message, the SMF may notify the UPF of PDU session status change information.

As a subject for performing the operation of FIG. 2, an EASDF may be a 5G network component responsible for a service control and data delivery function (i.e., an embedded access and mobility service control function). The EASDF is one of functions used in the 5G network and refers to a function of creating and managing policies and rules for service-oriented data flow. The EASDF may be used in conjunction with a network slicing function to provide various quality of service (QoS) levels.

The UDR stands for a user data repository and may be a component that stores and manages user data in the 5G network. The UDR is the data repository used in the 5G network. The UDR stores user profiles, policies, and other network-related data, and may be used by service providers to optimize services and improve user experience. The UDR may also be used in conjunction with the network slicing function to store and manage data for each service.

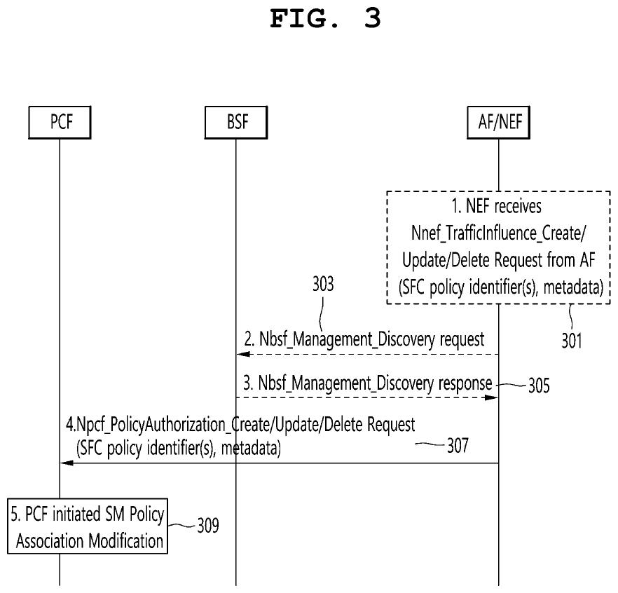

FIG. 3 is a view illustrating a signal flow diagram for a procedure in which an AF receives SFC information requested for one specific user and manages and processes the SFC information in a 5GS according to the exemplary embodiment of the present disclosure.

Referring to FIG. 3, in operation 301, when a service provider desires to apply an SFC service to an application of a piece of user equipment (UE), an SFC policy agreed upon in advance with each other through an AF or an NEF may be requested to a 5GS.

That is, in operation 301, the NEF may transmit an Nnef_TrafficInfluence_Create/Update/Delete Request message including SFC policy identifier(s) and metadata from the AF.

According to the exemplary embodiment, the Nnef_TrafficInfluence_Create/Update/Delete Request message is an interface request message for the network exposure function (NEF) to create, update, or delete Traffic Influence information in the 5G network. The Nnef_TrafficInfluence_Create/Update/Delete Request message may include various identifiers and information for identifying a target to which Traffic Influence is applied, along with the Traffic Influence information. The NEF that receives the Nnef_TrafficInfluence_Create/Update/Delete Request message may implement a Traffic Steering function by composing the Traffic Influence information.

According to the exemplary embodiment, operation 301 may use the same Nnef_TrafficInfluence service as that of operation 203 of FIG. 2 when requesting the SFC policy.

In operation 303, the AF or NEF may transmit an Nbsf_Management_Discovery Request message. According to the exemplary embodiment, the Nbsf_Management_Discovery Request message is a request message for searching information of a BSF in the network. The Nbsf_Management_Discovery Request message may be transmitted to all BSFs having network connectivity, and the Nbsf_Management_Discovery Request message may provide information on each discovered BSF. Through this way, a list of BSFs available on the network may be confirmed.

In operation 305, the BSF may transmit an Nbsf_Management_Discovery Response message to the AF or NEF.

According to the exemplary embodiment, the Nbsf_Management_Discovery Response message is one of messages for managing a binding support function (BSF) in the 5G network, and provides information on BSF. The Nbsf_Management_Discovery Response message is used by Nudm_Binding_Support service and may be used to return the information on BSF.

According to the exemplary embodiment, the BSF information may include a BSF ID, a BSF URI, a BSF type, etc.

In operation 307, by using an Npcf_PolicyAuthorization service interface, the NEF may transmit the SFC policy identifier and metadata received from the AF to the PCF serving a corresponding UE.

According to the exemplary embodiment, additional information for SFC may be defined according to a first method and a second method below on the basis of Npcf_PolicyAuthorization service operation. When initially making a request including parameters for requesting traffic steering from the NEF, the AF uses the Nnef_TrafficInfluence_Create service operation, and thereafter, in a case of requesting a routing change for corresponding traffic, the AF makes a request to the NEF by using the Nnef_TrafficInfluence_Update service operation including parameters for updating the existing traffic routing.

According to the first method, Nnef_TrafficInfluence_Create operation: Input (SFC policy identifier(s), metadata)

According to the second method, Nnef_TrafficInfluence_Update operation: Input (SFC policy identifier(s), metadata)

In operation 305, the BSF may transmit an Npcf_PolicyAutorization_Create/Update/Delete Request message. According to the exemplary embodiment, the Npcf_PolicyAutorization_Create/Update/Delete Request message is a message for requesting to create, update, or delete a PCC rule. The Npcf_PolicyAutorization_Create/Update/Delete Request message includes information related to the PCC rule, and the NEF may create, update, or delete the PCC rule on the basis of this information.

According to operation 307, the PCF may transmit new policy information including the identifier and metadata, which are mapped into one, to the session management function (SMF) according to the first to third methods below.

According to the exemplary embodiment, traffic steering rule(s) applied to the UPF based on the PCC rule received by the SMF may simultaneously use N6-IAN traffic steering and AF-influenced traffic steering for a piece of traffic.

According to the first method, an existing traffic steering policy (TSP) ID may be used as is.

According to the second method, an SFC ID input from the AF may be used as is.

According to the third method, the UPF may use a service function path (SFP) ID to be performed on an actual packet.

As a subject for performing the operation of FIG. 3, the binding support function (BSF) may be a server that authenticates a user and grants authority on the basis of information of a subscriber profile repository (SPR) in a 5G network. Through this way, a service provider may determine whether to provide services on the basis of the user's location and subscription information. In addition, the BSF may also serve in strengthening network security and ensuring the safety of user data.

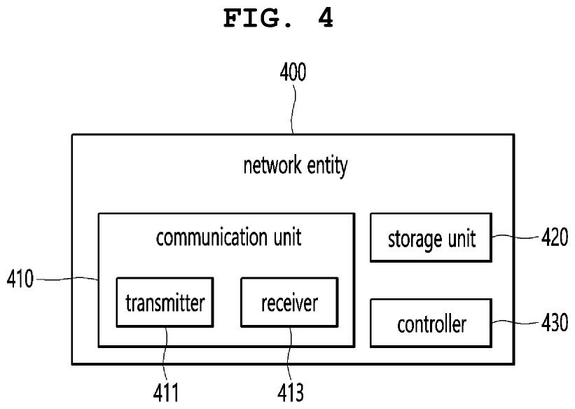

FIG. 4 is a view illustrating a configuration of a network entity in a wireless communication system according to various exemplary embodiments of the present disclosure. The network entity of the present disclosure is a concept that includes a network function in accordance with system implementation. Hereinafter, the terms used below, such as “˜part”, “˜group”, and the like, mean a unit for processing at least one function or operation and may be implemented by a combination of hardware and/or software. A network entity 400 according to the various exemplary embodiments of the present disclosure may include a communication unit 410, a storage unit 420, and a controller 430 configured to control the overall operations of the network entity 400. The communication unit 410 transmits and receives signals with other network entities. Accordingly, all or part of the communication unit 410 may be referred to as a “transmitter 411”, a “receiver 413”, or a “transceiver 410”. The storage unit 420 stores data such as fundamental programs, applications, and setting information for the operations of the network entity 400. The storage unit 420 may be comprised of a volatile memory, a non-volatile memory, or a combination of the volatile memory and non-volatile memory. In addition, the storage unit 420 provides stored data according to a request of the controller 430. The controller 430 controls the overall operations of the network entity 400. For example, the controller 430 transmits and receives signals through the communication unit 410. In addition, the controller 430 writes and reads data from the storage unit 420. In addition, the controller 430 may perform functions of protocol stacks required by communication standards. To this end, the controller 430 may include a circuit, an application-specific circuit, at least one processor or microprocessor, or may be a part of a processor. In addition, a part of the communication unit 410 and the controller 430 may be referred to as a communication processor (CP). The controller 430 may control the network entity 400 to perform operations of any one among various exemplary embodiments of the present disclosure. The communication unit 410 and the controller 430 do not necessarily have to be implemented as separate modules, but may naturally be implemented as a single component unit in the form of a single chip or a software block. The communication unit 410, storage unit 420, and controller 430 may be electrically connected to each other. In addition, the operations of the network entity 400 may be realized by providing in the storage unit 420 for storing corresponding program code in the network entity 400. The network entity 400 includes a network node, and may be any one of a base station (i.e., a RAN), AMF, SMF, UPF, NF, NEF, NRF, CF, NSSF, UDM, AF, AUSF, SCP, UDSF, UDR, BSF context repository, OAM, EMS, configuration server, or identifier (ID) management server.

According to various exemplary embodiments of the present disclosure, in the method for the 5G system (5GS) to support the N6-LAN traffic steering function by using the SFC technology, the 5GS may provide the SFC exposure service to request the SFC service from the AF.

According to the exemplary embodiment, the AF may be characterized by requesting an SFC service by using an Nnef_TrafficInfluence service interface and inputting an SFC policy identifier and a metadata value.

According to the exemplary embodiment, the PCF may be characterized by mapping a received SFC policy identifier to a PCC rule in the following three ways.

First method: mapping SFC policy to existing traffic steering policy (TSP) ID

Second method: mapping SFC policy to SFC ID as is, which is input from AF

Third method: mapping SFC policy to SFP ID to be performed by UPF on packet processing

According to the exemplary embodiment, a case where the AF requests a SFC service for a piece of UE may be characterized in that an SFC policy identifier and a metadata value are added to the Npcf_PolicyAuthorization service interface and transmitted to the PCF.

The methods according to the exemplary embodiments described in the claims or specification of the present disclosure may be implemented in the form of hardware, software, or a combination of hardware and software.

When implemented in software, a computer readable storage medium for storing one or more programs (i.e., software modules) may be provided. One or more programs stored in the computer-readable storage medium are configured for execution by one or more processors in an electronic device. One or more programs include instructions that cause the electronic device to execute the methods according to the exemplary embodiments described in the claims or specification of the present disclosure.

Such programs (i.e., software modules, software) may be stored in a random access memory, a non-volatile memory including a flash memory, a read only memory (ROM), an electrically erasable programmable read only memory (EEPROM), a magnetic disc storage device, a compact disc-ROM (CD-ROM), a digital versatile discs (DVDs) or other forms of optical storage devices, or a magnetic cassette. Alternatively, such programs may be stored in a memory composed of a combination of some or all thereof. In addition, a plurality of configuration memories may be included.

In addition, the programs may be stored in an attachable storage device that can be accessed through a communication network such as the Internet, an intranet, a local area network (LAN), a wide area network (WAN), or a storage area network (SAN), or through a communication network composed of a combination thereof. Such a storage device may be connected to a device for performing the exemplary embodiments of the present disclosure through an external port. In addition, a separate storage device on a communication network may be connected to a device for performing the exemplary embodiments of the present disclosure.

In the specific exemplary embodiments of the present disclosure described above, the components included in the disclosure are expressed in singular or plural numbers according to the specific exemplary embodiments presented. However, the singular or plural expressions are selected appropriately for the presented situation for convenience of description, and the present disclosure is not limited to the singular or plural components. Even components expressed in plural may be composed of a single component, or even a component expressed in a singular number may be composed of a plurality of components.

Meanwhile, in the detailed description of the present disclosure, specific exemplary embodiments have been described, but various modifications may be made without departing from the scope of the present disclosure. Therefore, the scope of the present disclosure should not be limited to the exemplary embodiments described above, but should be defined not only by the scope of claims described later, but also by those equivalent to the scope of these claims.

What is claimed is:

1. A method performed by an application function (AF) in a wireless communication system, the method comprising:
requesting a service function chaining (SFC) service from a network exposure function (NEF),
wherein the requesting the SFC service comprises the SFC service is requested by inputting an SFC policy identifier and a metadata value on a basis of an Nnef_TrafficInfluence service interface, and
wherein the SFC policy identifier is mapped to an identifier defined in a policy and charging control (PCC) rule.

2. The method of claim 1, wherein the SFC policy identifier is mapped to the identifier defined in the PCC rule by using an existing traffic steering policy (TSP) ID.

3. The method of claim 1, wherein the SFC policy identifier is mapped to the identifier defined in the PCC rule by using an SFC ID input from the AF.

4. The method of claim 1, wherein the SFC policy identifier is mapped to the identifier defined in the PCC rule by using a service function path (SFP) ID to be performed by a user plane function (UPF) on an actual packet.

5. The method of claim 1, further comprising:
transmitting, by the AF, new policy information comprising the identifier and metadata defined in the PCC rule to a session management function (SMF) via a policy control function (PCF).

6. The method of claim 1, further comprising:
transmitting, by the AF, forwarding action rule (FAR) forwarding information comprising the identifier and metadata defined in the PCC rule to a user plane function (UPF) via a session management function (SMF).

7. The method of claim 1, further comprising:
storing, by the NEF, the SFC policy identifier and metadata in a unified data repository (UDR).

8. The method of claim 7, wherein the UDR notifies a policy control function (PCF) that information comprised in the UDR has been updated.

9. The method of claim 1, wherein the identifier defined in the PCC rule is an identifier (ID) used inside a 5G system (5GS).

10. A method performed by a network exposure function (NEF) in a wireless communication system, the method comprising:
receiving a request of a service function chaining (SFC) service from an application function (AF),
wherein the receiving the request of the SFC service comprises the request of the SFC service is received by inputting an SFC policy identifier and a metadata value on a basis of an Nnef_TrafficInfluence service interface, and
wherein the SFC policy identifier is mapped to an identifier defined in a policy and charging control (PCC) rule.

11. The method of claim 10, wherein the SFC policy identifier is mapped to the identifier defined in the PCC rule by using an existing traffic steering policy (TSP) ID.

12. The method of claim 10, wherein the SFC policy identifier is mapped to the identifier defined in the PCC rule by using an SFC ID input from the AF.

13. The method of claim 10, wherein the SFC policy identifier is mapped to the identifier defined in the PCC rule by using a service function chaining (SFC) ID to be performed by the UPF on an actual packet.

14. The method of claim 10, further comprising:
receiving, by the NEF, new policy information comprising the identifier and the metadata defined in the PCC rule from a session management function (SMF) via a policy control function (PCF).

15. The method of claim 10, further comprising:
transmitting, by the NEF, forwarding action rule (FAR) forwarding information comprising the identifier and the metadata defined in the PCC rule to a user plane function (UPF) via a session management function (SMF).

16. The method of claim 10, further comprising:
storing, by the NEF, the SFC policy identifier and the metadata in a unified data repository (UDR).

17. The method of claim 16, wherein the UDR notifies a policy control function (PCF) that information comprised in the UDR has been updated.

18. The method of claim 16, wherein the identifier defined in the PCC rule is an identifier (ID) used inside a 5G system (5GS).

19. An apparatus of an application function (AF) in a wireless communication system, the apparatus comprising:
a transceiver unit; and
a controller operably connected to the transceiver,
wherein the controller is configured to:
request an SFC service from a network exposure function (NEF);
requests the SFC service by inputting an SFC policy identifier and a metadata value on a basis of an Nnef_TrafficInfluence service interface in order to request the SFC service; and
wherein the SFC policy identifier is mapped to an identifier defined in a PCC rule.
